(19) United States
(12) Patent Application Publication
(10) Pub. No.: US 2016/0094603 A1
(43) Pub. Date: Mar. 31, 2016

(54) AUDIO AND VIDEO SHARING METHOD AND SYSTEM

(71) Applicant: Wistron Corporation, New Taipei City (TW)

(72) Inventors: Fang-Wen Liao, New Taipei City (TW); Ping-Hung Chen, New Taipei City (TW); Pen-Tai Miao, New Taipei City (TW)

(21) Appl. No.: 14/542,678

(22) Filed: Nov. 17, 2014

(30) Foreign Application Priority Data
Sep. 29, 2014 (TW) 103133740

(51) Int. Cl. H04L 29/06; G06F 17/30; H04L 29/08

(52) U.S. Cl. CPC H04L 65/60; H04L 65/403; H04L 67/10; G06F 17/30058

(57) ABSTRACT

An audio and video sharing method and system is provided. The audio and video sharing method includes initializing a plurality of audio capturing modules in response to a plurality of applications, capturing the first audio data from the first application and the second audio data from the second application, generating the first audio and video stream based on the first audio data, and transmitting the first audio and video stream in response to the first audio and video sharing request. Accordingly, the system separately captures the audio stream from the different applications, and after appropriately coding, transmits the corresponding audio stream to the corresponding user, thereby sharing the corresponding audio stream individually in response to the request of each user.

### CROSS-REFERENCE TO RELATED APPLICATION

This application claims the priority benefit of Taiwan application serial no. 103133740, filed on Sep. 29, 2014. The entirety of the above-mentioned patent application is hereby incorporated by reference herein and made a part of this specification.

### BACKGROUND OF THE INVENTION

1. Field of the Invention

The invention relates to an audio and video sharing technology, and particularly relates to an audio and video sharing method and a system using the audio and video sharing method.

2. Description of Related Art

Under Moore's Law, the function of hardware devices becomes more and more powerful and relatively cheaper. Digital cameras and digital video cameras gradually become the consumer electronic products. Many people use digital cameras and digital video cameras to make home videos, keep records of their daily lives, or shoot micro films. A variety of media contents are then uploaded to cloud servers, or shared or spread to others through the streaming technology. However, management of the uploaded multimedia contents tends to be restricted to the service provider handling the server, or only limited privacy protection is offered. For example, it is not able to arbitrarily set the authorization level of viewing of some individuals or forbid a specific individual from viewing the contents. Nevertheless, with exploitation of the desktop sharing technology, even a personal computer, such as an all-in-one personal computer (AIO PC), can be used to share multimedia contents with others.

However, the audio file captured in the audio and video sharing technology is an audio signal output to a speaker. More specifically, if a variety of applications are activated simultaneously, and all of the applications output audio signals to the speaker, the audio contents received at the client device are a combination of audio contents of all of the applications activated on the host, instead of the separate audio contents. Thus, further works need to be done to correctly transmit the audio contents of the application designated by the user.

### SUMMARY OF THE INVENTION

The invention provides an audio and video sharing method and system capable of capturing an audio stream of a specific application, and, after appropriately coding, transmitting a coded audio and video stream in response to a request of a user device.

An audio and video sharing method according to an exemplary embodiment of the invention includes: receiving a first audio and video sharing request from a network; initializing a plurality of audio capturing modules in response to a plurality of applications; capturing a first audio data from a first application by using a first audio capturing module of the audio capturing modules, and capturing a second audio data from a second application by using a second audio capturing module of the audio capturing modules; and generating a first audio and video stream according to the first audio data received from an audio engine and transmitting the first audio and video stream through the communication module in response to the first audio and video sharing request.

According to an exemplary embodiment of the invention, the audio and video sharing method further includes generating the first audio and video stream according to the first audio data received from the audio engine and graphic data received from a graphics device interface module.

According to an exemplary embodiment of the invention, the audio and video sharing method further includes: obtaining a first original audio data from a terminal buffer corresponding to the first application; converting the first original audio data into the first audio data compliant with a sound format; storing the first audio data; and retrieving the first audio data and transmitting the retrieved first audio data to a stream processing module.

According to an exemplary embodiment of the invention, the audio and video sharing method further includes transmitting, from a mobile device, the first audio and video sharing request corresponding to the first application to a server through the network.

According to an exemplary embodiment of the invention, the audio and video sharing method further includes: initializing the audio capturing modules to obtain a processing identification code corresponding to each of the applications; obtaining the first audio data from the first audio capturing module of the audio capturing modules according to the processing identification code corresponding to the first application; and generating the first audio and video stream, and transmitting the first audio and video stream to the mobile electronic device through the communication module via the network.

According to an exemplary embodiment of the invention, the audio and video sharing method further includes receiving the first audio and video stream from the server and playing the first audio and video stream.

According to an exemplary embodiment of the invention, the audio and video sharing method further includes generating a second audio and video stream according to the second audio data received from the audio engine, and transmitting the first audio and video stream through the communication module in response to a second audio and video sharing request.

According to an exemplary embodiment of the invention, the audio and video sharing method further includes playing the second audio data, and not playing the first audio data, through an audio driver of the server and a speaker.

An audio and video sharing system according to an exemplary embodiment of the invention includes: a processor unit, a buffer memory, a communication module, an audio engine, and a stream processing module. The buffer memory, the communication module, the audio engine, and the stream processing module are respectively coupled to the processor unit. More specifically, the communication module is configured to be connected to a network and receive a first audio and video sharing request from the network. The audio engine initializes a plurality of audio capturing modules in response to a plurality of applications. A first audio capturing module of the audio capturing modules captures a first audio data from a first application and a second audio capturing module of the audio capturing modules captures a second audio data from a second application. The stream processing module generates a first audio and video stream according to the first audio data received from the audio engine, and transmits the first audio and video stream through the communication module in response to the first audio and video sharing request.

According to an exemplary embodiment of the invention, the audio and video sharing system further includes a graphics device interface module. The graphics device interface module processes a graphic data from the first application. In addition, the stream processing module generates the first audio and video stream according to the first audio data received from the audio engine and the graphic data received from the graphics device interface module.

According to an exemplary embodiment of the invention, the first audio capturing module obtains a first original audio data from a terminal buffer corresponding to the first application, converts the first original audio data into the first audio data compliant with a sound format, stores the first audio data in the buffer memory, retrieves the first audio data from the buffer memory, and transmits the retrieved first audio data to the stream processing module.

According to an exemplary embodiment of the invention, the audio and video sharing system further includes a server and a mobile electronic device. The processor unit, the buffer memory, the communication module, the audio engine, and the stream processing module are disposed in the server. In addition, the mobile electronic device transmits the first audio and video sharing request corresponding to the first application to the server through the network.

According to an exemplary embodiment of the invention, the audio engine initializes the audio capturing modules to obtain a processing identification code corresponding to each of the applications. The stream processing module obtains the first audio data from the first audio capturing module of the audio capturing modules according to the processing identification code corresponding to the first application. Then, the stream processing module generates the first audio and video stream, and transmits the first audio and video stream to the mobile electronic device through the communication module via the network.

According to an exemplary embodiment of the invention, the mobile electronic device receives the first audio and video stream from the server and plays the first audio and video stream.

According to an exemplary embodiment of the invention, the stream processing module generates a second audio and video stream according to the second audio data received from the audio engine, and transmits the first audio and video stream through the communication module in response to a second audio and video sharing request.

According to an exemplary embodiment of the invention, the audio engine plays the second audio data, but not plays the first audio data, through an audio driver of the server and a speaker.

Based on the above, in the audio and video sharing system and the audio and video sharing method according to the exemplary embodiments of the invention, the audio data are respectively captured from the applications to improve the issue that the audio data are unable to be separated in the desktop sharing technology. In addition, the captured audio data are able to be converted into an appropriate sound format and output to the electronic device of the user.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an audio and video sharing system according to an exemplary embodiment of the invention.

FIG. 2 is a block diagram illustrating a server of an audio and video sharing system according to a first exemplary embodiment of the invention.

FIG. 3 is a schematic view illustrating use of the audio and video sharing system according to the first exemplary embodiment of the invention.

FIG. 4 is a flowchart illustrating an audio and video sharing method according to the first exemplary embodiment of the invention.

FIG. 5 is a schematic view illustrating use of an audio and video sharing system according to a second exemplary embodiment of the invention.

FIG. 6 is a flowchart illustrating an audio and video sharing method according to the second exemplary embodiment of the invention.

FIG. 7 is a block diagram illustrating an audio and video sharing system according to a third exemplary embodiment of the invention.

FIG. 8 is a schematic view illustrating use of an audio and video sharing system according to a third exemplary embodiment of the invention.

FIG. 9 is a schematic block diagram illustrating an audio and video sharing system according to a fourth exemplary embodiment of the invention.

FIG. 10 is a flowchart illustrating an audio and video sharing method according to the fourth exemplary embodiment of the invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

In the invention, audio data and graphic data of different applications are respectively captured and converted, and then converted audio and video streams are transmitted in packets to different user electronic devices. Therefore, the audio and video streams received by the user electronic devices are correct audio data and not mixed with audio data of other applications.

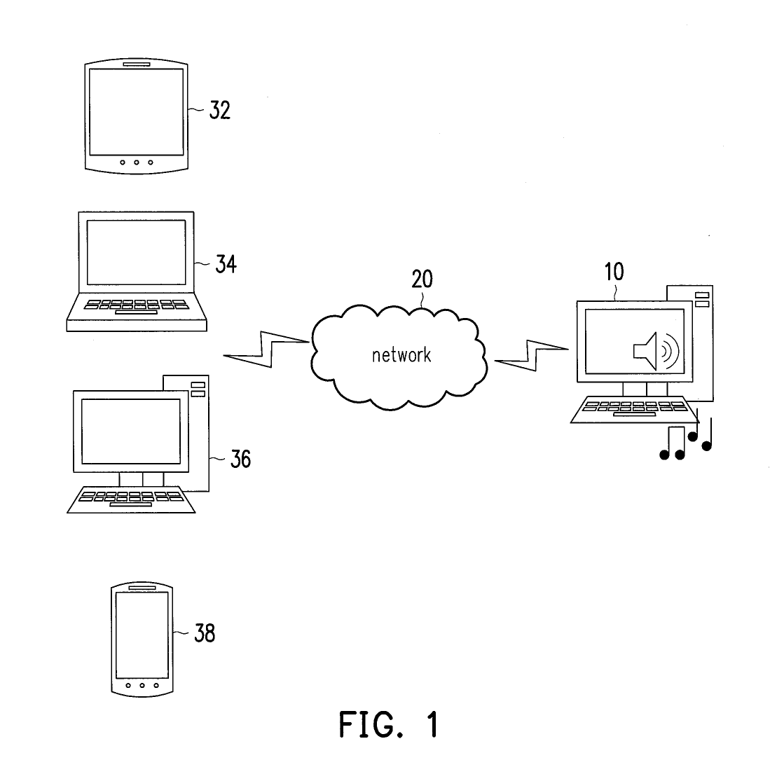

FIG. 1 is a schematic view illustrating an audio and video sharing system according to an exemplary embodiment of the invention.

Referring to FIG. 1, the audio and video sharing system includes a server 10, a network 20, and electronic devices 32, 34, 36, and 38.

An operating system is loaded on the server 10, and an application is operated on the server 10. Here, the operating system may be Microsoft Windows, Apple Macintosh, or Linux systems, and the invention is not limited thereto.

In this exemplary embodiment, the server 10, the electronic device 32, the electronic device 34, the electronic device 36, and the electronic device 38 are connected through the network 20. For example, the network 20 follows a transmission standard of an Internet communication protocol in this exemplary embodiment. For example, the transmission standard of the Internet communication protocol here may be a transmission control protocol/Internet protocol (TCP/IP) or a user datagram protocol/Internet protocol (UDP/IP). However, the invention is not limited thereto. In another exemplary embodiment of the invention, the network 20 may also be a wireless local area network (WLAN) established according to a transmission standard of a local network communication protocol. For example, the transmission standard of the local network communication protocol is a series of 802.11 standards set up by the Institute of Electrical and Electronics Engineers (IEEE).

In this exemplary embodiment, the electronic device 32 is a tablet computer, the electronic device 34 is a portable computer, the electronic device 36 is a desktop computer or a personal computer, and the electronic device 38 is a mobile phone.

However, the electronic devices may be electronic devices in other forms, and the invention is not limited by forms of the electronic devices. More specifically, in this exemplary embodiment, the electronic devices 32, 34, 36, and 38 may send an audio and video sharing request to the server 10 through the network 20, and the audio and video sharing request requests to share audio and video contents of a specific application operated on the server 10.

In the following, details of the embodiments of the invention are described with reference to the concept of audio and video sharing set forth in the foregoing.

### First Exemplary Embodiment

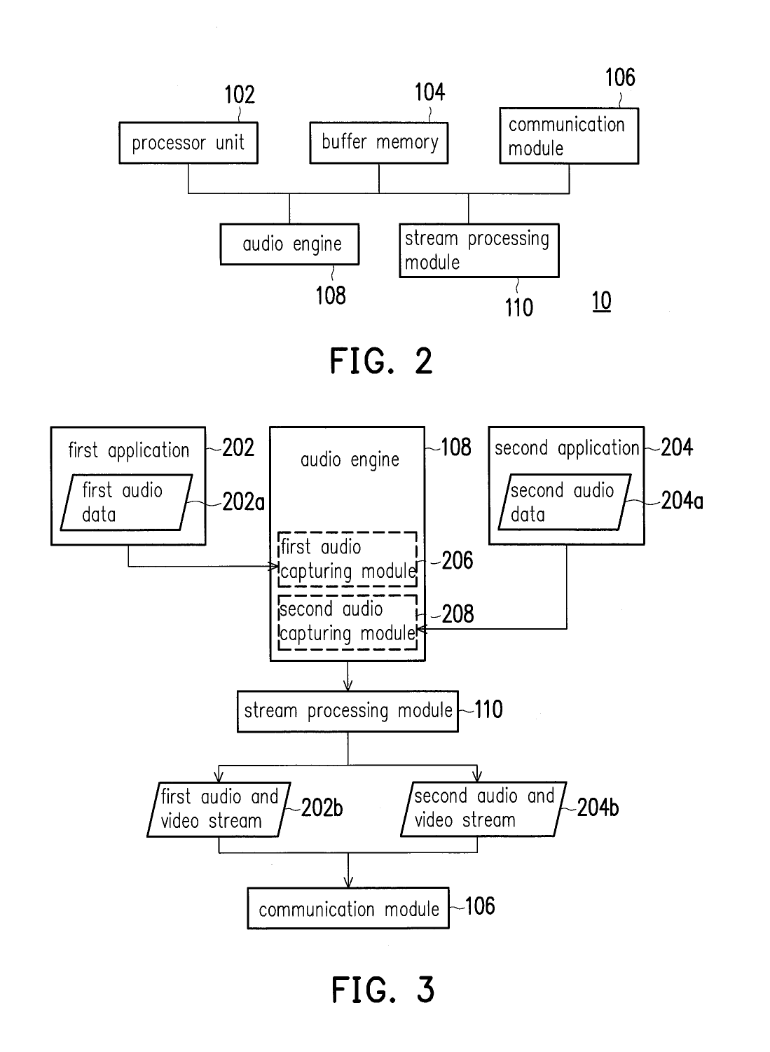

FIG. 2 is a block diagram illustrating a server of an audio and video sharing system according to a first exemplary embodiment of the invention.

Referring to FIG. 2, the server 10 includes a processor unit 102, a buffer memory 104, a communication module 106, an audio engine 108, and a stream processing module 110.

In this exemplary embodiment, the processor unit 102 is, for example, a central processing unit (CPU), a programmable microprocessor, a digital signal processor (DSP), a programmable controller, an application specific integrated circuit (ASIC), a programmable logic device (PLD), or other similar devices.

The buffer memory 104 is configured to store a variety of data such as audio or graphic data in a process. For example, the buffer memory 104 is a random access memory (RAM), a read-only memory (ROM), a flash memory, etc.

The communication module 106 is coupled to the processor unit 102. The communication module 106 is configured to be connected to the network 20, and is operated by using a transmission standard or communication protocol compatible with the network 20. For example, the communication module 106 may transmit packets to the electronic device 32, the electronic device 34, the electronic 36, and the electronic device 38 or receive packets from the electronic device 32, the electronic device 34, the electronic 36, and the electronic device 38, through the network 20.

The audio engine 108 is coupled to the processor unit 102 to capture an audio data.

The stream processing module 110 is coupled to the processor unit 102. The stream processing module 110 is configured to generate an audio and video stream according to the audio data captured by the audio engine 108 and respond to the sharing request by transmitting the audio and video stream in packets through the communication module 106 via the network 20 in response to the sharing request. For example, the stream processing module 110 may convert a sound format of the audio data captured by the audio engine 108. The sound format may be, for example, a waveform audio format (WAV), a motion picture experts group audio layer 3 (MP3), Windows media audio format (WMA), ogging format (OGG), or audio video interleave format (AVI), etc. In addition, the invention is not limited thereto.

FIG. 3 is a schematic view illustrating use of the audio and video sharing system according to the first exemplary embodiment of the invention.

Referring to FIG. 3, a first application 202 and a second application 204 are operated on the server 10. For example, the first application 202 and the second application 204 are loaded to the buffer memory 104 and executed by the processor unit 102. More specifically, when the first application 202 and the second application 204 are being operated, the first application 202 generates a first audio data 202a, and the second application 204 generates a second audio data 204a.

A first audio capturing module 206 and a second audio capturing module 208 are included in the audio engine 108. In addition, when the first application 202 and the second application 204 are being operated, the first audio capturing module 206 and the second audio capturing module 208 are initialized to capture the audio data. Here, the first audio capturing module 206 is initialized to capture the first audio data 202a generated by the first application 202, and the second audio capturing module 208 is initialized to capture the second audio data 204a generated by the second application 204.

A first audio and video stream 202b and a second audio and video stream 204b are generated by the stream processing module 110 according to the first audio data 202a and the second audio data 204a received from the audio engine 108. In other words, the stream processing module 110 generates the first audio and video stream 202b according to the first audio data 202a, and generates the second audio and video stream 204b according to the second audio data 204a. More specifically, in this exemplary embodiment, when the server 10 receives a sharing request to the first application 202 from the electronic device 32, the electronic device 34, the electronic device 36, or the electronic device 38, the stream processing module 110 generates the first audio and video stream 202b according to the captured first audio data 202a of the first application 202 received from the first audio capturing module 206, and the communication module 106 transmits the generated first audio and video stream 202b in response to the sharing request to the first application 202.

Also, it should be noted that at the same time when the generated first audio and video stream 202b is transmitted in response to the sharing request to the first application 202, if a sharing request to the second application 204 is received from the electronic device 32, the electronic device 34, the electronic device 36, or the electronic device 38, the stream processing module 110 also generates the second audio and video stream 204b corresponding to the second application 204 according to the second audio data 204a received from the audio engine 108, and the communication module 106 transmits the second audio and video stream 204b corresponding to the second application 204 in response to the audio and video sharing request to the second application 204.

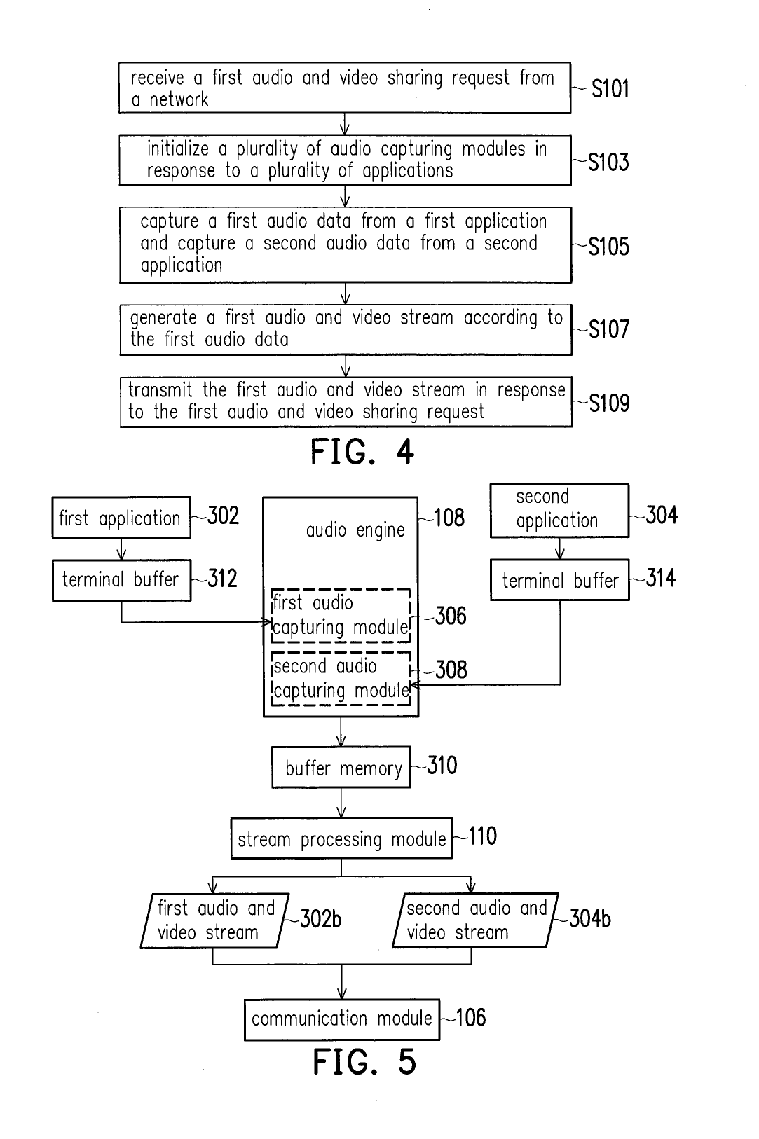

FIG. 4 is a flowchart illustrating an audio and video sharing method according to the first exemplary embodiment of the invention.

Referring to FIG. 4, first of all, the communication module 106 receives a first audio and video sharing request from the network, as shown in Step S 101. Then, as shown in Step S103, the audio engine 108 initializes a plurality of audio capturing modules in response to a plurality of applications. More specifically, at Step S103, the audio engine 108 initializes the first audio capturing module 206 and the second audio capturing module 208.

For example, the first audio capturing module 206 and the second audio capturing module 208 are system effects audio processing objects (sAPO). During audio capturing, the first audio capturing module 206 and the second audio capturing module 208 negotiate with an audio service provider and establish a data format. Interfaces thereof are IAudioProcessingObject::IsInputFormatSupported, AudioProcessingObject::LockForProcess, and IAudioProcessingObjectConfiguration::UnlockForProcess. In addition, the first audio capturing module 206 and the second audio capturing module 208 write data through an INF file. A definition is set as follows:

### ;; Property Keys

PKEY_FX_PreMixClsid =“{D04E05A6-594B-4fb6-A80D-01AF5EED7D1D},1”

For example, during initialization of the first audio capturing module 206 and the second audio capturing module 208, firstly, an interface of CBaseAudioProcessingObject is inherited, and then Class is established through PID.

Then, the interface of IAudioProcessingObject:IsInputFormatSupported and the audio engine are used to mutually communicate about the data format, and the IAudioProcessingObjectRT::APOProcess is used for audio signal processing. Then, a detailed audio format information is stored through the interface of ValidateAndCacheConnectionInfo

At Step S105, the first audio capturing module 206 captures the first audio data 202a of the first application 202, and the second audio capturing module 208 captures the second audio data 204a of the second application 204.

For example, capturing the received audio data may be achieved by a program as follows:

### IAudioProcessingObjectRT::APO_Process (

UINT32 u32NumInputConnections, APO_CONNECTION_PROPERTY**
ppInputConnections,
UINT32 u32NumOutputConnections, APO_CONNECTION_PROPERTY** ppOutputConnections)
In addition, APO_CONNECTION_PROPERTY″ ppInputConnections is an input audio data of the application.

At Step S107, the stream processing module 110 generates the first audio and video stream 202b corresponding to the first application 202 according to the first audio data 202a received from the audio engine 108, and the stream processing module 110 generates the second audio and video stream 204b corresponding to the second application 204 according to the second audio data 204a received from the audio engine 108.

At Step S109, the communication module 106 transmits the first audio and video stream 202b corresponding to the first application 202 in response to the audio and video sharing request to the first application 202.

In addition, in another exemplary embodiment of the invention, at Step S 107, the stream processing module 110 also generates the second audio and video stream 204b corresponding to the second application 204 according to the second audio data 204a received from the audio engine 108. In addition, at Step S109, the communication module 106 sends the second audio and video stream 204b corresponding to the second application 204 in response to the audio and video sharing request to the second application 204.

### Second Exemplary Embodiment

FIG. 5 is a schematic view illustrating use of an audio and video sharing system according to a second exemplary embodiment of the invention.

Referring to FIG. 5, a communication module, an audio engine, and a stream processing module of the second exemplary embodiment are structurally and functionally substantially the same as the communication module, the audio engine, and the stream processing module labeled with the same reference numerals in FIG. 2. Therefore, details of the similarities will not be further reiterated in the following.

A first application 302, a second application 304, a first audio capturing module 306, and a second audio capturing module 308 are structurally and functionally substantially the same as the first application 202, the second application 204, the first audio capturing module 206, and the second audio capturing module 208 shown in FIG. 3. Thus, details of the similarities will not be further reiterated in the following.

In this exemplary embodiment, a terminal buffer 312 corresponds to the first application 302 and is configured to store a first original audio data (not shown) of the first application 302. A second terminal buffer 314 corresponds to the second application 304, and is configured to store a second original audio data (not shown) of the second application 304.

A buffer memory 310 is configured to store audio data received from the stream processing module 110.

More specifically, after capturing the first original audio data from the terminal buffer 312, the first audio capturing module 306 converts the first original audio data into the first audio data compliant with the sound format and stores the first audio data in the buffer memory 310. Then, the first audio data is transmitted to the stream processing module 110 from the buffer memory 310 to generate a first audio and video stream 302b. Lastly, the communication module 106 transmits the first audio and video stream 302b in response to the sharing request. Similarly, regarding the sharing request to the second application 304, firstly, after capturing the second original audio data from the terminal buffer 314, the second audio capturing module 308 converts the second original audio data into the second audio data compliant with the sound format and store the second audio data in the buffer memory 310. Then, the second audio data is transmitted to the stream processing module 110 from the buffer memory 310 to generate the second audio and video stream 304b. Lastly, the communication module 106 transmits the second audio and video stream 304b in response to the sharing request.

More specifically, conversion for compliance with the sound format may be performed by a program as follows:

FLOAT32 *pf32InputFrames, *pf32OutputFrames
pf32InputFrames=reinterpret_cast<FLOAT32*>(ppInputConnections [0]->pBuffer)

Meanwhile, retrieving the audio data from the buffer memory 310 may be performed by a program as follows:

CopyMemory(pf32OutputFrames, pf32InputFrames, ppInputConnections [0]->u32ValidFrameCount * GetBytesPerSampleContainer( )* GetSamplesPerFrame())

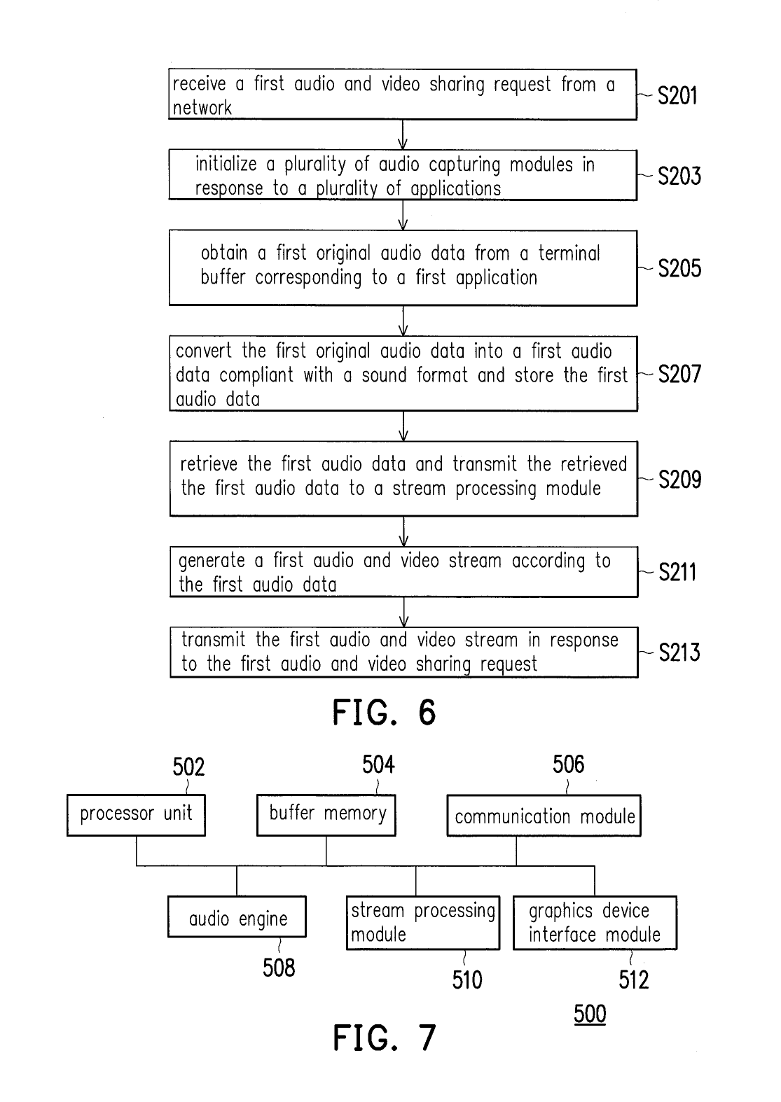

FIG. 6 is a flowchart illustrating an audio and video sharing method according to the second exemplary embodiment of the invention.

Referring to FIG. 6, at Step S201, the communication module 106 receives the first audio and video sharing request from the network. At Step S203, the audio engine 108 initializes the first audio capturing module 306 and the second audio capturing module 308 in response to the sharing requests to the first application 302 and the second application 304.

At Step 205, the first audio capturing module 306 obtains the first original audio data (not shown) from the terminal buffer 312 corresponding to the first application 302, and the second audio capturing module 308 obtains the second original audio data (not shown) from the terminal buffer 314 corresponding to the second application 304.

At Step S207, the first audio capturing module 306 converts the first original audio data into the first audio data compliant with the sound format and stores the first audio data in the buffer memory 310, and the second audio capturing module 308 converts the second original audio data into the second audio data compliant with the sound format and stores the second audio data in the buffer memory 310.

At Step S209, the audio engine 108 retrieves the first audio data and the second audio data from the buffer memory 310 and transmits the first and second audio data to the stream processing module 110.

At Step S211, the stream processing module 110 generates the first audio and video stream 302b according to the first audio data received form the audio engine 108, and the stream processing module 110 generates the second audio and video stream 304b according to the second audio data received from the audio engine 108.

At Step 5213, the communication module 106 respectively transmits the first audio and video stream 302b and the second audio and video stream 304b to the corresponding audio and video sharing requests.

### Third Exemplary Embodiment

FIG. 7 is a block diagram illustrating an audio and video sharing system according to a third exemplary embodiment of the invention.

Referring to FIG. 7, in this exemplary embodiment, a server 500 includes a processor unit 502, a buffer memory 504, a communication module 506, an audio engine 508, a stream processing module 510, and a graphics device interface module 512.

Structures of the processor unit 502, the buffer memory 504, the communication module 506, the audio engine 508, and the stream processing module 510 are structurally substantially the same as the processor unit 102, the buffer 104, the communication module 106, the audio engine 108, and the stream processing module 110. Therefore, details of the similarities will not be reiterated in the following.

The graphics device interface module 512 is coupled to the processor unit 502 to process graphic data from an application.

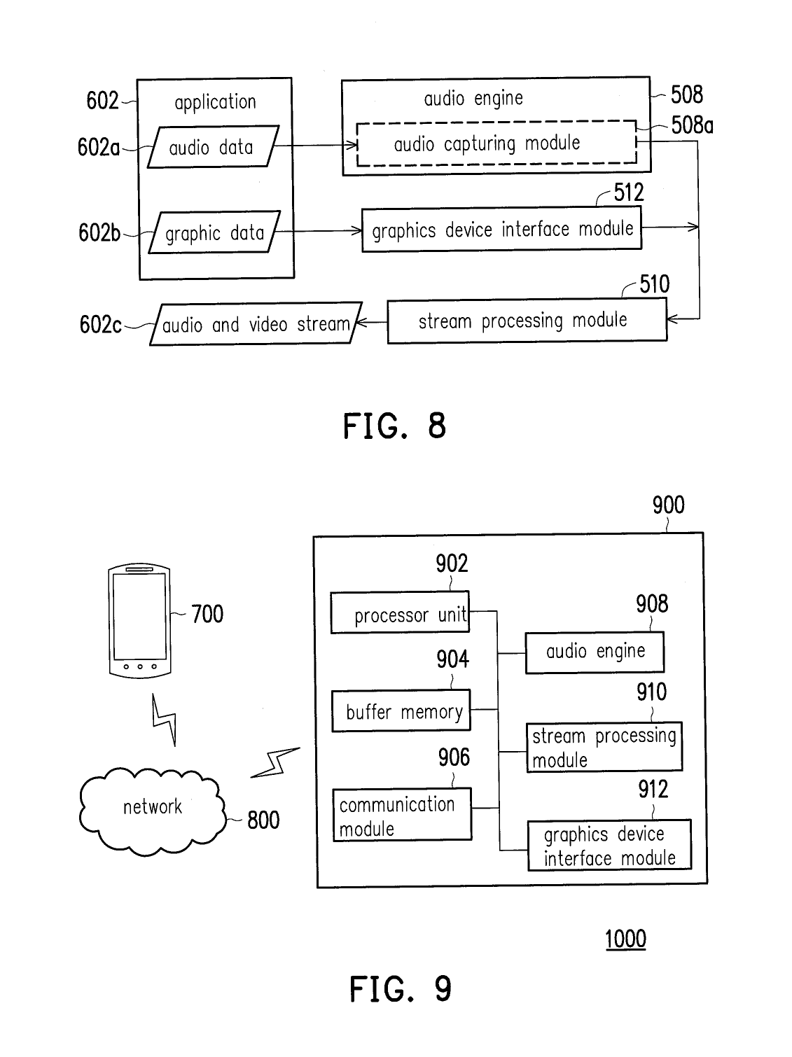

FIG. 8 is a schematic view illustrating use of an audio and video sharing system according to a third exemplary embodiment of the invention.

Referring FIG. 8, to be more specific, when the server 500 receives a sharing request to an application 602 operated on the server 500, the audio engine 508 initializes the audio capturing module 508a, and the audio capturing module 508a is configured to capture an audio data 602a of the application 602, and the graphics device interface module 512 captures a graphic data 602b in the application 602. The captured audio data 602a and graphic data 602b are transmitted to the stream processing module 510 to generate an audio and video stream 602c, and then the generated audio and video stream 602c is transmitted by the communication module 510 in response to the sharing request to the application 602.

### Fourth Exemplary Embodiment

FIG. 9 is a schematic diagram illustrating an audio and video sharing system according to a fourth exemplary embodiment of the invention.

Referring to FIG. 9, in this exemplary embodiment, an audio and video sharing system 1000 includes a server 900 and a mobile electronic device 700. In this exemplary embodiment, the mobile electronic device 700 and a network 800 are functionally substantially the same as the electronic devices 32 to 38 and the network 20 of FIG. 1. Therefore, details of the similarities will not be reiterated in the following.

Here, the mobile electronic device 700 transmits an audio and video sharing request to the server 900 through the network 800.

In this exemplary embodiment, the server 900 includes a processor unit 902, a buffer memory 904, a communication module 906, an audio engine 908, and a stream processing module 910. In addition, the server 900 may further include a graphics device interface module 912 in another exemplary embodiment of the invention.

Structures of the processor unit 902, the buffer memory 904, the communication module 906, the audio engine 908, the stream processing module 910, and the graphics device interface module 912 are substantially the same as those of the processor unit 502, the buffer memory 506, the audio engine 508, the stream processing module 510, and the graphics device interface module 512. Thus, details of the similarities will not be further reiterated in the following.

In this exemplary embodiment, when the mobile electronic device 700 transmits the audio and video sharing request corresponding to the first application to the server 900 through the network 800, the audio engine 908 initializes the first audio capturing module and obtains a first processing identification code of the first application. Then, the stream processing module 910 captures the first audio data from the first audio capturing module according to the first processing identification code corresponding to the first application and generates the first audio and video stream. Lastly, the communication module 906 transmits the first audio and video stream to the mobile electronic device 700 through the network 800.

In addition, in another exemplary embodiment of the invention, after receiving the first audio and video stream corresponding to the first application of the server 900, the mobile electronic device 700 plays the first audio and video stream.

In particular, in an exemplary embodiment of the invention, the audio engine 908 may play the second audio data, but not the first audio data, by using an audio driver (not shown) of the server 900 and a speaker (not shown).

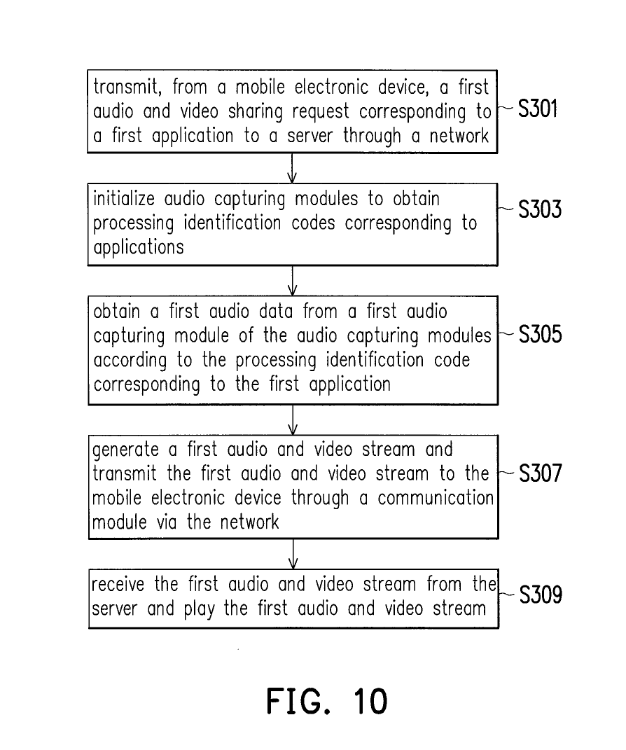

FIG. 10 is a flowchart illustrating an audio and video sharing method according to the fourth exemplary embodiment of the invention.

Referring to FIG. 10, at Step S301, the mobile electronic device 700 transmits the first audio and video sharing request corresponding to the first application (not shown) to the server 900 through the network 800.

At Step 303, the audio engine 908 initializes the audio capturing module to obtain a processing identification code of a corresponding application.

At Step S305, the stream processing module 901 obtains the first audio data from the first audio capturing module of the audio capturing modules according to the processing identification code corresponding to the first application.

At Step S307, the stream processing module 910 generates the first audio and video stream and transmits the first audio and video stream to the mobile electronic device 700 through the mobile communication module 906 via the network 800.

At Step S309, the audio electronic device 700 receives the first audio and video stream from the server 900 and plays the first audio and video stream.

It should be noted that in the exemplary embodiments, some program codes are used to describe how the exemplary embodiments are implemented. However, the program codes only serve as examples of implementing the invention, instead of serving to limit the invention.

In view of the foregoing, in the audio and video sharing method and system according to the exemplary embodiments of the invention, the audio data and graphic data of the application are separately captured, and the data are converted into the audio and video stream after being appropriately coded, and then the converted audio and video stream is transmitted to the user electronic device in packets, so as to offer the user a more preferable audio and video sharing quality and experience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio and video sharing method, comprising:
receiving a first audio and video sharing request from a network;
initializing a plurality of audio capturing modules in response to a plurality of applications;
capturing a first audio data from a first application by using a first audio capturing module of the audio capturing modules, and capturing a second audio data from a second application by using a second audio capturing module of the audio capturing modules;
generating a first audio and video stream according to the first audio data received from an audio engine; and
transmitting the first audio and video stream in response to the first audio and video sharing request.

2. The audio and video sharing method as claimed in claim 1, further comprising:
generating the first audio and video stream according to the first audio data received from the audio engine and a graphic data received from a graphics device interface module.

3. The audio and video sharing method as claimed in claim 1, further comprising:
obtaining a first original audio data from a terminal buffer corresponding to the first application;
converting the first original audio data into the first audio data compliant with a sound format;
storing the first audio data; and
retrieving the first audio data and transmitting the retrieved first audio data to a stream processing module.

4. The audio and video sharing method as claimed in claim 1, further comprising:
transmitting, from a mobile device, the first audio and video sharing request corresponding to the first application to a server through the network.

5. The audio and video sharing method as claimed in claim 4, further comprising:
initializing the audio capturing modules to obtain a processing identification code corresponding to each of the applications;
obtaining the first audio data from the first audio capturing module of the audio capturing modules according to the processing identification code corresponding to the first application; and
generating the first audio and video stream, and transmitting the first audio and video stream to the mobile electronic device through the communication module via the network.

6. The audio and video sharing method as claimed in claim 5, further comprising:
receiving the first audio and video stream from the server and playing the first audio and video stream.

7. The audio and video sharing method as claimed in claim 1, further comprising:
generating a second audio and video stream according to the second audio data received from the audio engine, and transmitting the second audio and video stream through the communication module in response to a second audio and video sharing request.

8. The audio and video sharing method as claimed in claim 4, further comprising:
playing the second audio data, and not playing the first audio data, through an audio driver of the server and a speaker.

9. An audio and video sharing system, comprising:
a processor unit;
a buffer memory, coupled to the processor unit;
a communication module, coupled to the processor unit and the buffer memory, wherein the communication module is connected to a network and receives a first audio and video sharing request from the network;
an audio engine, coupled to the processor unit, the buffer memory, and the communication module, wherein the audio engine initializes a plurality of audio capturing modules in response to a plurality of applications, a first audio capturing module of the audio capturing modules captures a first audio data from a first application and a second audio capturing module of the audio capturing modules captures a second audio data from a second application; and
a stream processing module, coupled to the processor unit, the buffer memory, the communication module, and the audio engine,
wherein the stream processing module generates a first audio and video stream according to the first audio data received from the audio engine, and transmits the first audio and video stream through the communication module in response to the first audio and video sharing request.

10. The audio and video sharing system as claimed in claim 9, further comprising a graphics device interface module processing a graphic data from the first application,
wherein the stream processing module generates the first audio and video stream according to the first audio data received from the audio engine and the graphic data received from the graphics device interface module.

11. The audio and video sharing system as claimed in claim 9, wherein the first audio capturing module obtains a first original audio data from a terminal buffer corresponding to the first application, converts the first original audio data into the first audio data compliant with a sound format, stores the first audio data in the buffer memory, retrieves the first audio data from the buffer memory, and transmits the retrieved first audio data to the stream processing module.

12. The audio and video sharing system as claimed in claim 9, further comprising:
a server, wherein the processor unit, the buffer memory, the communication module, the audio engine, and the stream processing module are disposed in the server; and
a mobile electronic device,
wherein the mobile electronic device transmits the first audio and video sharing request corresponding to the first application to the server through the network.

13. The audio and video sharing system as claimed in claim 12, wherein the audio engine initializes the audio capturing modules to obtain a processing identification code corresponding to each of the applications, and
the stream processing module obtains the first audio data from the first audio capturing module of the audio capturing modules according to the processing identification code corresponding to the first application, generates the first audio and video stream, and transmits the first audio and video stream to the mobile device through the communication module via the network.

14. The audio and video sharing system as claimed in claim 13, wherein the mobile electronic device receives the first audio and video stream from the server and plays the first audio and video stream.

15. The audio and video sharing system as claimed in claim 9, wherein the stream processing module generates a second audio and video stream according to the second audio data received from the audio engine, and transmits the second audio and video stream through the communication module in response to a second audio and video sharing request.

16. The audio and video sharing system as claimed in claim 12, wherein the audio engine plays the second audio data, but not plays the first audio data, through an audio driver of the server and a speaker.
